(19) United States
(12) Patent Application Publication
(10) Pub. No.: US 2015/0073941 A1
(43) Pub. Date: Mar. 12, 2015

(54) HOTEL FINDER INTERFACE

(71) Applicants: Emma Burrows, Zurich (CH); Andrew J. McCarthy, Zurich (CH); Aleksandra K. Wozniak, Poznan (PL); Stefan H. Pharies, Zurich (CH); Amar Singh Sagoo, Thalwil (CH)

(72) Inventors: Emma Burrows, Zurich (CH); Andrew J. McCarthy, Zurich (CH); Aleksandra K. Wozniak, Poznan (PL); Stefan H. Pharies, Zurich (CH); Amar Singh Sagoo, Thalwil (CH)

(21) Appl. No.: 14/364,842

(22) PCT Filed: Dec. 13, 2011
(86) PCT No.: PCT/PL2011/000133

§ 371 Date: Jun. 12, 2014

(51) Int. Cl. G06Q 30/06; G06F 17/30

(52) U.S. Cl. CPC G06Q 30/0625; G06F 17/30061; G06Q 30/0639
USPC 705/26.62

(57) ABSTRACT

Methods, systems, and apparatus, including computer programs encoded on a computer storage medium, for receiving a search query, where the search query includes one or more terms; identifying one or more locations associated with the one or more terms prior to execution of the search query; providing the one or more locations as query suggestions; receiving a selection of a location; and in response to the selection, determining that the selected location references a hotel and providing a hotel search results interface, the hotel search results interface including a first region displaying one or more hotel listings, where the hotels listings include hotels located within a geographic region containing the selected hotel, and a second region, where the second region is configured to present one or more user selected hotels from the one or more hotel listings.

### BACKGROUND

This specification relates to information retrieval.

Users can use various web sites to plan travel including reserving hotel stays. Conventionally, a user navigates to either a web site corresponding to a particular entity (e.g., a site belonging to a specific hotel or hotel brand) or to a web based travel booking site that provides access to several different hotels. Once the user has identified an itinerary for travel (e.g., a particular hotel for a particular date range), they can typically purchase the itinerary directly through the web site.

### SUMMARY

This specification describes technologies relating to information retrieval.

Users can search for hotels by submitting a search query to a search system, where the search query includes a location. The location can be a geographic region (e.g., a city, state, neighborhood, or address), a particular hotel, or a point of interest. Particular locations can be suggested in response to a search query. The suggested locations can include geographic regions, hotels, and points of interest that are associated with the submitted query. Users can select a suggested location to obtain information (e.g., particular search results) responsive to the selected location.

In some implementations, a user selects a geographic region from the suggested locations. Selecting a geographic region can result in hotel locations responsive the suggested location being provided for display on a map interface. The hotel locations can be displayed using, for example, graphics or icons. Hotel locations shown on a map can include some (e.g., a subset of all hotels) or all hotels within in the geographic region or particular hotels within the geographic region that satisfy a user's search criteria. Filters can be drawn to encompass areas based on hotel locations. For example, polygon-shaped filters can be drawn around a particular geographic region. Users can manipulate the drawn polygon-shaped filters (e.g., by dragging the polygon to different regions on the map or by adjusting the polygon vertices) to restrict or to enlarge the polygon-shaped filters which reduces or increases, respectively, the number of hotel locations displayed on a map.

In some implementations, a user selects a hotel from the suggested locations. Selection of a hotel can result in a search being performed to identify hotels located within a geographic region and that are associated with the selected hotel. Additionally, selection of a hotel can result in the selected hotel being added to a shortlist of user selected hotels. The shortlist can be provided in a hotel results interface, which the user can use to compare the hotels in the shortlist prior to making a purchasing decision.

In some implementations, a user selects a point of interest from the suggested locations. Selection of a point of interest can result in a display of a map interface for a geographic region associated with the point of interest. Additionally, a map indicator can be displayed over the map interface to identify the selected point of interest together with hotels located within the same geographic region that is associated with the point of interest. Users can select hotels displayed on the map interface based in part on their proximity to the map indicator identifying the selected point of interest. In some implementations, users can add and/or delete map indicators identifying points of interest on a geographic region.

In general, one aspect of the subject matter described in this specification can be embodied in methods that include the actions of receiving a search query, where the search query includes one or more terms; identifying one or more locations associated with the one or more terms prior to execution of the search query; providing the one or more locations as query suggestions; receiving a selection of a location; and in response to the selection, determining that the selected location references a hotel and providing a hotel search results interface, the hotel search results interface including a first region displaying one or more hotel listings, where the hotels listings include hotels located within a geographic region containing the selected hotel, and a second region, where the second region is configured to present one or more user selected hotels from the one or more hotel listings. Other embodiments of this aspect include corresponding systems, apparatus, and computer program products.

These and other embodiments can optionally include one or more of the following features. The hotel search results interface includes a third region that is configured to present a hotel card for the hotel corresponding to the selected location as an overlay to the first and second regions. The hotel corresponding to the selected location is added to a shortlist of user selected hotels.

In general, another aspect of the subject matter described in this specification can be embodied in methods that include the actions of receiving a search query, where the search query includes one or more terms; identifying one or more locations associated with the one or more terms prior to execution of the search query; providing the one or more locations as query suggestions; receiving a selection of a location; and in response to the selection, determining that the selected location references a point of interest and providing a map interface, the map interface including a map of a geographic region that includes the point of interest, wherein the map interface identifies the selected point of interest and hotels located within the geographic region including the selected point of interest. Other embodiments of this aspect include corresponding systems, apparatus, and computer program products.

These and other embodiments can optionally include one or more of the following features. The selected point of interest is identified using a marker, and where the marker is selectable by a user to obtain additional information about the point of interest. The method further includes receiving user input for removing the selected point of interest from the map interface; and updating the map interface to remove the selected point of interest.

The method further includes receiving a second search query, where the second search query includes one or more terms; identifying one or more locations associated with the one or more terms prior to execution of the second search query; providing the one or more locations as query suggestions; receiving a second selection of a location; and in response to the second selection, determining that the selected location references a second point of interest and updating the map interface, the map interface including a map of a geographic region that includes the point of interest and the second point of interest, wherein the map interface identifies the point of interest, the second point of interest, and hotels located within the geographic region including the selected point of interest.

Particular embodiments of the subject matter described in this specification can be implemented so as to realize one or more of the following advantages. Users can search for hotels based on a specified geographic region, a specified hotel, or a specified point of interest. Suggestions for geographic regions, hotels, and points of interest can be provided to the user as the user types a search query.

Users searching for a geographic region can be provided with a list of hotels that are available within the specified geographic region. Users can also be provided with a map interface displaying the specified geographic region with a map indicator indicating the location of the geographic region on the map. The user can use the map indicator as a reference point to gauge the distance from a particular hotel to the specified geographic region when booking hotels.

Users searching for a specific hotel can be provided with a list of hotels that are available within a geographic region corresponding to the specified hotel, together with a hotel card providing details for the specified hotel.

Users searching for a point of interest can be provided with a map interface displaying a geographic region corresponding to the specified point of interest. The map can use a map indicator to indicate the location of the specified point of interest and display hotels located within the geographic region corresponding to the specified point of interest. The user can use the point of interest indicator as a reference point to gauge the distance from a particular hotel to the specified point of interest when booking hotels.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a flow diagram of an example process for providing locations.

FIG. 3 is an example hotel search interface.

FIG. 4 is an example hotel results interface.

FIG. 5 is an example map interface including a map pin identifying a geographic region.

FIG. 6 is an example map interface including a map pin identifying a point of interest.

Like reference numbers and designations in the various drawings indicate like elements.

### DETAILED DESCRIPTION

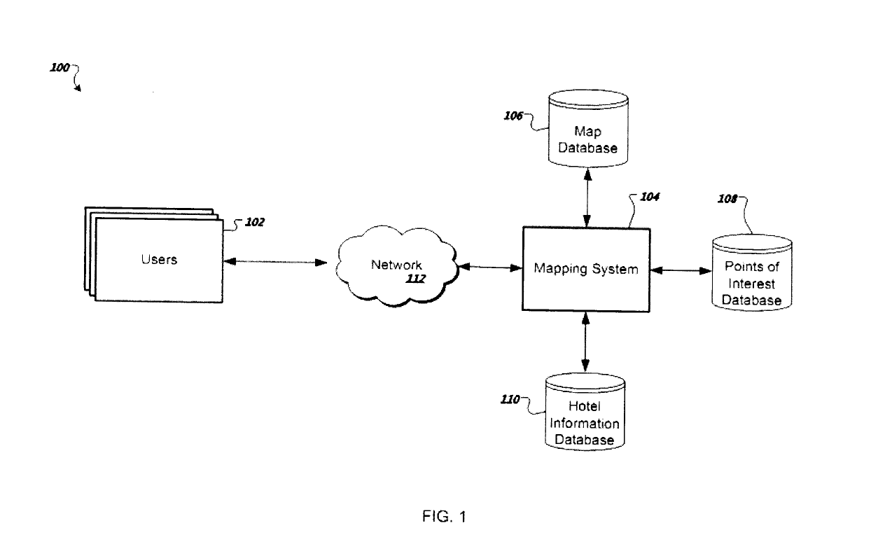

FIG. 1 is a block diagram of an example system 100. The system 100 includes a mapping system 104 in communication with one or more users 102 through a network 112. In particular, the mapping system 104 receives information from a map database 106 in order to provide mapping data for displaying particular geographic regions. The map database 106 can store, for example, different types of maps for geographic regions (e.g., two-dimensional maps, three-dimensional maps, and satellite maps). The mapping system 104 can receive information from various other databases (e.g., a traffic database) and can display the received information.

A user can interact with the mapping system 104 through a client device. For example, the client device can be a computer coupled to the mapping system 104 through a network 112. The network 112 can be a local area network (LAN), a wide area network (WAN), the Internet, one or more telephony or wireless networks, or a combination thereof. The client device will generally include a random access memory (RAM) and a processor. A user can submit a query to the mapping system 104. When the user submits a query, the query is transmitted through a network to the mapping system 104. The mapping system 104 can be implemented as, for example, computer programs running on one or more computers in one or more locations that are coupled to each other through a network.

Additionally, the mapping system 104 obtains information pertaining to points of interest from a points of interest database 108. The points of interest database 108 can store, for example, points of interests located in various geographic regions. Further, the mapping system 104 receives hotel information from a hotel database 110, for example, to determine locations of hotels for identification on a map, e.g., when the hotels are responsive to particular hotel search parameters. The hotel database 110 can store, for example, a listing of hotels for a geographic region, corresponding pricing information, dates of availability, and location. The term “hotel” as used in the specification can refer generically to various types of accommodations including hotels, motels, lodges, or resorts. Information pertaining to various accommodations (e.g., hotels, motels, lodges, and resorts) can be stored in different databases, the same database, or as a combination of databases.

The mapping system 104 uses the obtained map information and points of interest information to identify areas containing points of interest on a map of a geographic region. The areas containing points of interest can be identified in advance or in response to a user request for a particular geographic region. In some implementations, the mapping system 104 can display a map indicator identifying a point of interest on a map of a geographic region in response to a search query for that point of interest. The mapping system 104 uses the obtained map information, points of interest information, and hotel information to display geographic regions, hotel locations, and points of interest on a map. In some implementations, the hotels displayed on a map are determined based on additional user specified search criteria (e.g., hotel price, location, class, and reviews).

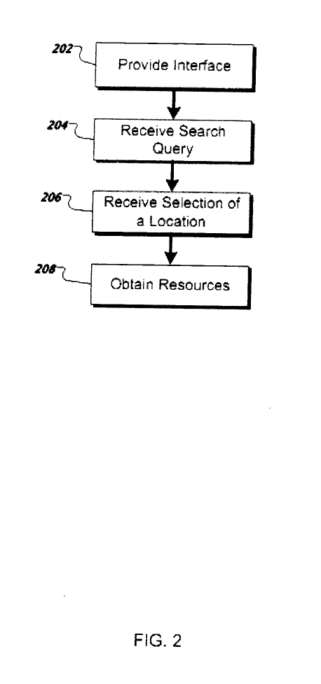

FIG. 2 is a flow diagram of an example process 200 for providing locations. For convenience, the process 200 will be described with respect to a system (e.g., system 100) including one or more computing devices that performs the process 200.

The system provides a search interface (202). The search interface can be part of a separate travel site or initiated through a particular search interface. The search interface can be accessed directly by the user, for example, by accessing a travel search web page. Alternatively, a user can enter a query “hotels” or “hotels San Francisco” in a search interface and be directed to the travel search interface. In another example, the user can provide a query to a map search interface that specifies a request for hotels in a particular geographic location (e.g., “hotels san Francisco” or “hotels 94107”). In some implementations, user provides a query to a map search interface that specifies a request for hotels in proximity to a particular point of interest (e.g., “hotels empire state building”).

The provided search interface can include one or more search parameters particular to the travel type. For example, for a hotel search, the search parameters can include a location and one or more travel dates. The location can be a particular geographic region, for example, a particular neighborhood, city, region, or country. The travel dates can include both a check-in and check-out date or a check-in date and a number of nights. Other parameters can also be provided by the search interface, for example, indicating a type of room (e.g., king, double), smoking preferences, hotel class, or reviewer rating.

The system receives a search query (204). Search queries can be received from a client device communicating over a network, where the client device interacts with the system using an interface, such as a network interface. The search query can include one or more terms received from a user. For example, the search query can be “Eiffel.” In some implementations, a user enters a search query including one or more terms, where the terms include a location. In some implementations, the location is a name for a geographic region. In some other implementations, the location is a hotel. In yet some other implementations, the location is point of interest.

During entry of the search query to the system, suggestions can be provided to the user (e.g., in a drop-down menu) so that the user can select from different options. The suggestions can be suggested queries including the same or additional autocompleted query terms. In some implementations, the suggestions are based on other users' search activities. The suggestions can be algorithmically determined based on a number of objective factors (e.g., popularity of search terms) without human intervention. For example, the user can enter “xyz hotel,” and the system can provide suggested queries “XYZ Hotel, New York, N.Y.,” “XYZ Hotel, San Francisco, Calif.,” “XYZ Hotel, Dublin, Ireland,” and/or “XYZ Hotel, Shanghai, China.” The system can provide the suggestions based on a word-completion algorithm. Alternatively, the system can provide the suggestions based on historical data from prior search terms.

In some implementations, the system provides suggestions for one or more locations that correspond to terms received from the user. The one or more locations can include geographic regions, names of hotels, and points of interest. For example, the user input of “empire” can result in suggested queries for “Empire State Building, New York, N.Y.,” “Empire Hotel Roof Top Bar, West 63rd Street, New York, N.Y.,” “Empire Landmark Hotel, Vancouver, British Columbia, Canada,” and “Empire, CA.”

In some implementations, instant search results are provided based in part upon entry of one or more characters in the search query. For example, the user can enter a search query for “ma,” and search results provided can include search results with phrases “Massachusetts,” “Maine,” and “Maryland,” each matching the search term “ma.” The user can continue with the search by inputting more characters and the search results can be updated instantly based on the entered characters. In some implementations, the search results are instantly updated based in part on the user hovering over one of the suggestions provided in the drop-down menu.

The system receives a selection of a location (206). The user can select a location by selecting a suggested query from one or more suggested queries. The suggested query can include a reference to a query for a location (e.g., geographic regions, hotels, or points of interest). In response to the selection, the system can present one or more interfaces based on the selected location. For example, selecting a geographic region can result in the system providing a map interface containing a map of the geographic region for display. Selecting a particular hotel can result in the system providing a hotel search results interface. Further, selecting a point of interest can result in the system providing a map interface containing a map of a geographic region that contains the point of interest. In some implementations, a search query including a name for a particular location is entered and submitted without selecting a suggested location, and, in response, the system identifies resources related to the particular location.

The system provides information responsive to the selected location (208). In some implementations, the system determines a type corresponding to the selected location and provides information based at least in part on the type of the selected location. For example, the system can provide different information depending on whether the type of the selected location is a geographic region, a hotel, or a point of interest. In some implementations, the system determines a type corresponding to the selected location by performing a database lookup using the selected location. For example, the system can determine a type by looking up a selected location (e.g., Manhattan, XYZ Hotel, or Empire State Building) using one or more of a map database, a hotel information database, and a points of interest database, and determining which database contains information responsive to the selected location.

In some implementations, in a scenario where the selected location is a geographic region, the system provides a map interface containing a map of the geographic region for display. The map interface can include one or more bounding filters that encompass areas that contain a threshold number of points of interest. Additionally, the map interface can indicate geographic locations of that are hotels located within the selected geographic region. Moreover, the map interface can identify the selected geographic region using an indicator. For example, the geographic region can be identified using an icon (e.g., a balloon-shaped pin), a text box containing a name for the geographic region, a thumbnail image of the geographic region, or a combination thereof.

In some other implementations, in a scenario where the selected location is a particular hotel, the system provides a hotel search results interface. The hotel search results interface can include a region that displays hotel listings for hotels that are located within a geographic region corresponding to the particular hotel. The hotel search results interface can also include a second region that is configured to present a hotel shortlist containing one or more user selected hotels from the displayed hotel listings. In some implementations, the hotel search results interface includes a third region that is configured to present a hotel card for the selected hotel as an overlay to the first and second regions. The hotel card can contain details pertaining to the particular hotel selected by the user (e.g., ratings, reviews, amenities, price, and reservations available). In some implementations, the particular hotel is added to the hotel shortlist, which can be used to compare hotels prior to making a purchasing decision.

In yet some other implementations, in a scenario where the selected location is a point of interest, the system provides a map interface containing a map of a geographic region that contains the point of interest. The point of interest can be identified on the map using various indicators. For example, the point of interest can be identified using an icon (e.g., a balloon-shaped pin), a text box containing a name for the point of interest, a thumbnail image of the point of interest, or a combination thereof. In particular, points of interest can include places visited by tourists, places visited by locals, restaurants, shopping locations, entertainment locations, and particular geographic locations. Additionally, the map interface can display hotels located near the selected point of interest. Users can use the point of interest as a reference point when deciding between candidate hotels.

In some implementations, the map indicator for the point of interest is updated by revising the search query to include a different geographic region or point of interest. In some other implementations, searching for additional geographic regions or points of interest results in additional map indicators being displayed on the map. In various implementations, users can refine the number of hotels displayed on a map by selecting a map indicator identifying a geographic region or a point of interest. For example, a user can click on a map indicator to specify that only hotels located within a specified distance from the map indicator should be displayed on the map interface.

For example, a user wanting to book a hotel stay near the Empire State Building can search for “empire state building.” In response to the query, the system can provide a map interface containing a map of a geographic region that contains the Empire State Building (e.g., Manhattan). The system can identify the Empire State Building on the map using a map indicator (e.g., a balloon-shaped pin). The system can also indicate on the map locations of hotels that are located within the geographic region that contains the Empire State Building.

In some implementations, the system indicates on the map a subset of all hotel locations based at least in part on specified criteria. For example, the system can indicate locations of hotels that satisfy user specified filtering parameters (e.g., show only hotels with a hotel rating of 4 or more stars). In some other implementations, the user can refine the query to filter the displayed hotels. For example, a map showing hotel locations in a geographic region can be updated to show hotel locations for particular hotels (e.g., XYZ Hotel) by refining the query (e.g., as “empire state building xyz hotel” or “xyz hotel”). In to response to the query revision, the system can provide hotel locations for all XYZ Hotels available in the geographic region (e.g., “XYZ Hotel, 11 Madison Ave., New York, N.Y.,” “XYZ Hotel, 55 Park Ave., New York, N.Y.,” and “XYZ Hotel, 913 Columbus Ave., New York, N.Y.”).

Using the map interface, the user can visually determine geographic locations of candidate hotels in relation to the Empire State Building. The user can obtain additional information about a particular hotel by selecting the hotel from the map interface (e.g., view pictures or videos associated with the particular hotel, check hotel availability, and see average prices for selected travel dates). In some implementations, users are directed to one or more travel sites, where the users can book hotel stays at selected hotels. Alternatively, the user can add a particular hotel to a hotel shortlist, which can be used to compare hotels prior to making a purchasing decision using various criteria (e.g., hotel class, user ratings, price, and hotel deal).

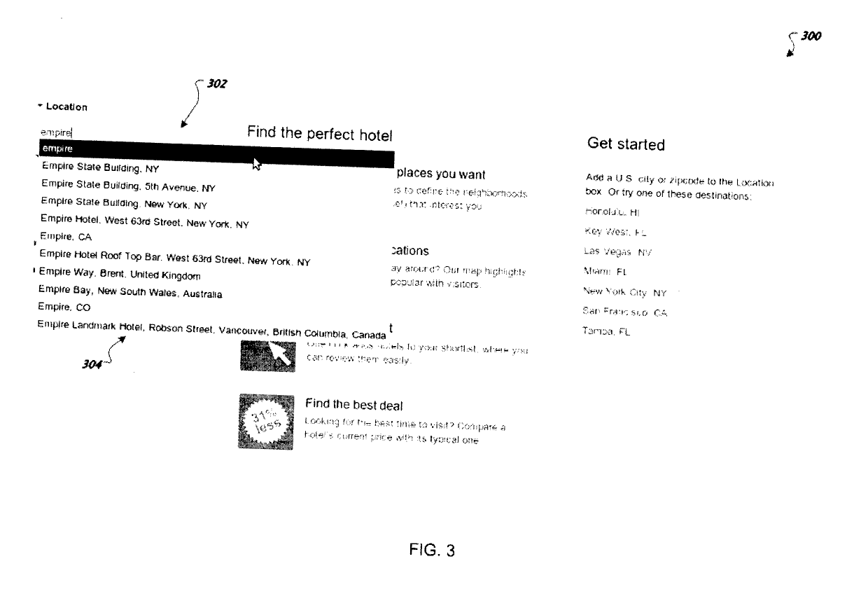

FIG. 3 is an example hotel search interface 300. The hotel search interface 300 includes a location search box 302, which can be used to search for locations (e.g., a geographic region, a hotel, or a point of interest). A suggested locations drop-down menu 304 is shown. The suggested locations drop-down menu 304 can provide to a user suggested locations that match the user's input during entry of a search query to the system. For example, the user has typed “empire” in the location search box 302. In response to the typing, the system has provided suggested locations in the drop-down menu 304. In particular, the suggested locations include one or more geographic regions (e.g., “Empire, CA”), one or more hotels (e.g., “Empire Landmark Hotel, Robson Street, Vancouver, British Columbia, Canada”), and one or more points of interest (e.g., “Empire State Building, NY,” “Empire Hotel Roof Top Bar, West 63rd Street, New York, N.Y.”). The user can complete the search query by selecting one of the suggested locations from the suggested entities drop-down menu 304.

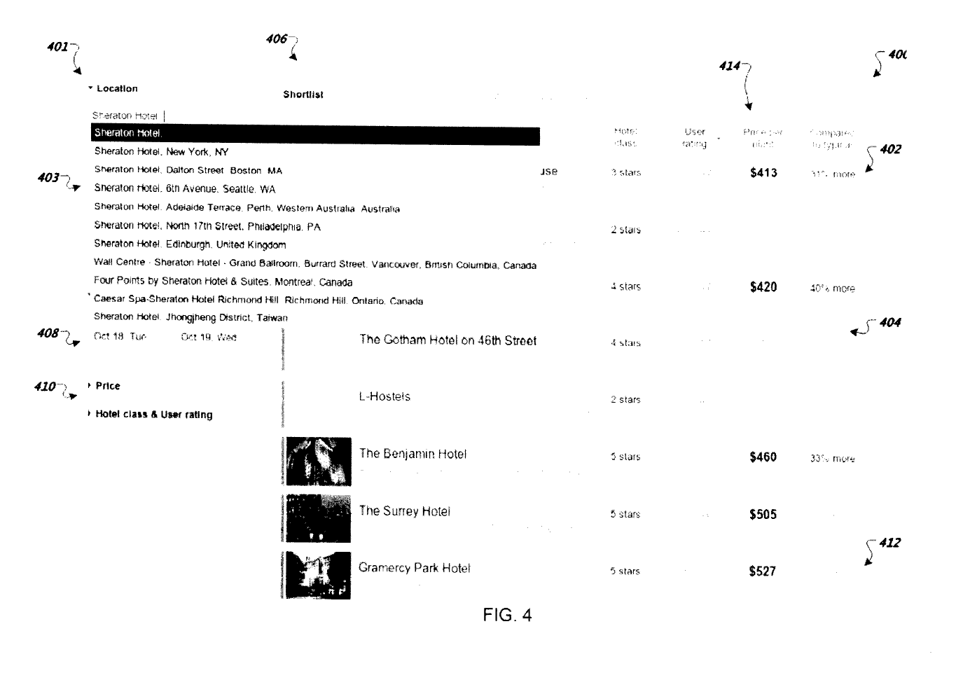

FIG. 4 is an example hotel results interface 400. The hotel results interface 400 includes a first region 402 displaying a listing of hotel results 404, a second region 406 for displaying a hotel shortlist, dates 408, and filtering parameters 410. The hotel results interface 400 also shows an location search box 401 and a suggested locations drop-down menu 403.

The suggested locations drop-down menu 403 can provide to a user suggested locations that match the user's search query during entry of a search query to the system using the location search box 401. For example, the user has typed “XYZ Hotel” in the location search box 401. In response to the typing, the system has provided suggested locations in the drop-down menu 403. In particular, the suggested locations include various hotels matching “XYZ Hotel” (e.g., “XYZ Hotel, New York, N.Y.”, “XYZ Hotel, Edinburgh, United Kingdom”, and “XYZ Hotel, Jhongjheng District, Taiwan”). The user can complete the search query by selecting one of the suggested locations from the suggested locations drop-down menu 403.

In some other implementations, the system provides a hotel search results interface that includes a region that displays hotel listings for hotels that are located within a geographic region corresponding to the selected hotel. For example, selection of “XYZ Hotel, New York, N.Y.” can result in display of hotel listings for hotels that are located within New York, N.Y. The hotel search results interface can also include a second region that is configured to present a hotel shortlist containing one or more user selected hotels from the displayed hotel listings. For example, the “XYZ Hotel, New York, N.Y.” hotel can be added to the hotel shortlist, since it was selected by the user. In some implementations, the hotel search results interface includes a third region that is configured to present a hotel card for the selected hotel “XYZ Hotel, New York, N.Y.” as an overlay to the first and second regions. The hotel card can contain details pertaining to the “XYZ Hotel, New York, N.Y.” (e.g., ratings, reviews, amenities, price, and reservations available).

The listing of hotel results 404 includes a number of separate listings for hotels responsive to a search query. For example, the hotel results 404 include hotel listings responsive to a geographic region, New York, N.Y., for the dates of October 18 to October 19 (as shown in dates 408). The listing can include additional hotel results not shown, but accessible though user interaction with the hotel results interface 400 (e.g., using scroll bar or links to additional pages of results).

Each of the individual listings includes summary information about the particular hotel. For example, hotel result 412 includes the hotel name, a representative image, a hotel rating, a user rating, a price per night, and a comparison of the price per night to the hotel's typical price. The hotel result 412 also includes an excerpt (e.g., a snippet) of a review. The hotel result 412 can be selected by the user and added to a hotel shortlist 406. Adding the hotel result to the shortlist adds the particular hotel to the second region 406. The user can then assemble one or more hotels from the listing of hotel results 404 within the second region 406. In some alternative implementations, a user can drag and drop hotel results to the second region 406 to add them to the shortlist. Additionally, the user can order the hotels within the shortlist.

The listing of hotel results 404 also includes a number of sorting headers 414 that the user can select in order to modify the ordering of the hotels included in the listing of hotel results 404. The sorting headers 414 include the hotel class, the user rating, the price per night, and the relative price comparing the price per night to the hotel's typical price.

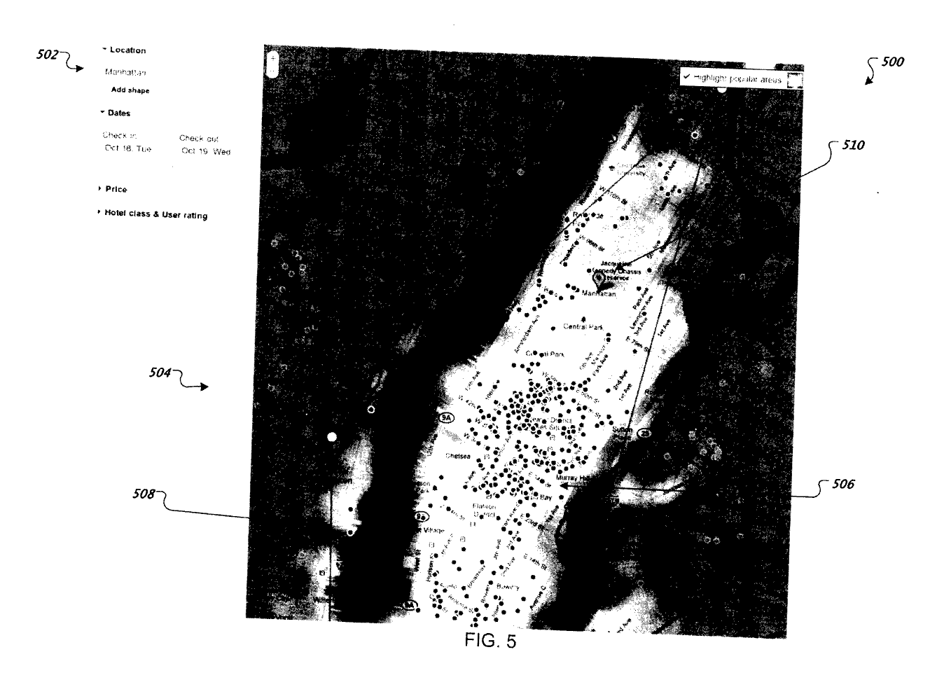

The map region, which is not visible because of the suggested location drop-down menu 403, can display the geographic locations for one or more of the hotels displayed in the listing of hotel results 404. A bounding polygon can define a region in which all the hotels are located. In some implementations, selection of the map allows the user to view additional details about the location or to modify the selected area in which hotel results are located (e.g., as bound by the polygon), as discussed in more detail in connection with FIG. 5.

The dates 408 are editable so that the user can modify the dates for the hotel stay. For example, the user can modify the check in date, the check-out date, or both. The filtering parameters 410 include a number of separate filtering parameters that can be used to refine the provided results. The filtering parameters 410 shown include filters for price, hotel class, user rating, and amenities. Selection of a particular type of filtering parameter can results in an expansion displaying one or more filtering options for that filtering parameter. A subsequent selection of the filtering parameter can collapse the filtering options.

While the example listing of hotel results shown in FIG. 4 includes, for example, prices and hotel ratings, other hotel results interfaces can present listings of hotel results that have some, all, or none of these features. For example, prices may not be shown and/or hotel ratings may not be shown.

FIG. 5 is an example map interface 500 including a map indicator identifying a geographic region 510. The map 500 is displayed in response to a user search query for a geographic region for “Manhattan.” The map 500 includes a search filter 502, which has been populated with “Manhattan.” The search filter 502 can be used to input a search query or to refine an existing query (e.g., based on geographic region, a particular hotel, or a point of interest). For example, a user can enter a query “XYZ hotel” and then refine the provided results by entering the query “XYX hotel new york.” The user can also refine a query for “XYZ hotel” to “XYZ hotel empire state building” to identify a particular XYZ Hotel that is located near the Empire State Building.

The map region 504 displays map results responsive to the query. This includes both a geographic representation of the location identified by the query (in this case, New York) as well as additional markers. In particular, the map region 504 includes hotel markers 506 for identifying the location of specific hotels within the geographic region. In some implementations, a marker is directly selectable by a user in order to obtain additional information about the hotel. In addition, the map region 504 shows an adjustable polygon-shaped filter 508. The polygon-shaped filter 508 encompasses an area identified to contain a threshold number of points of interests. Only hotels within the polygon-shaped filter 508 are indicated. In addition, the polygon-shaped filter is adjustable to increase or decrease the number of hotels shown. In particular, the map region 504 indicates the geographic location for “Manhattan” using a map indicator 510. The map indicator 510 provides a reference point for the user when deciding between candidate hotels.

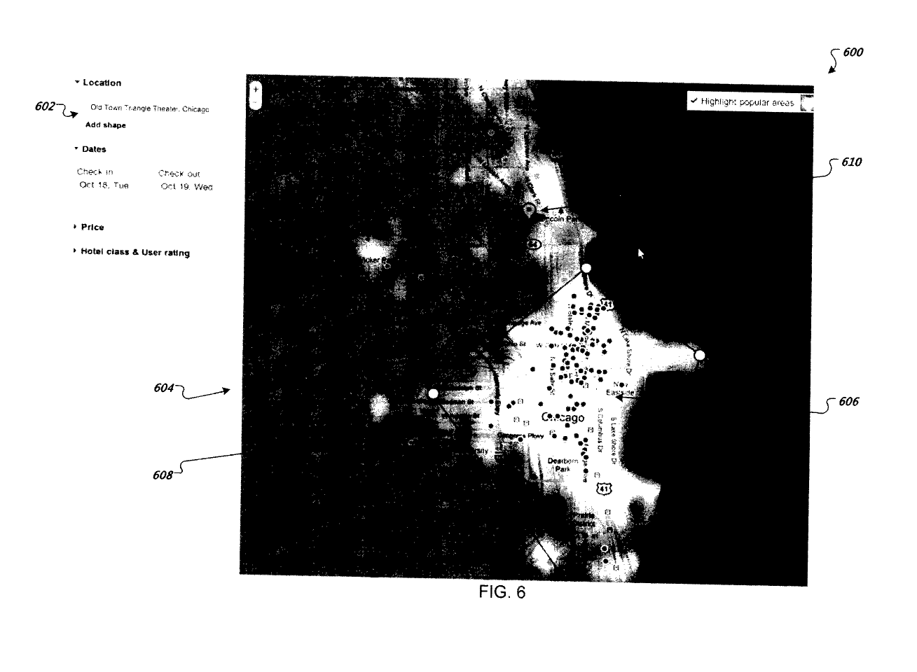

FIG. 6 is an example map interface 600 including a map indicator identifying a point of interest 610. The map 600 is displayed in response to a user search query for a point of interest for “Old Town Triangle Theater, Chicago.” The map 600 includes a search filter 602. The search filter 602 can be used to input a search query or to refine an existing query (e.g., based on geographic region, a particular hotel, or a point of interest). For example, a user can enter a query “XYZ hotel” and then refine the provided results by entering the query “XYX hotel new york.” The user can also refine a query for “XYZ hotel” to “XYZ hotel empire state building” to identify a particular XYZ Hotel that is located near the Empire State Building.”

The map region 604 displays map results responsive to the query. This includes both a geographic representation of the location corresponding to the point of interest identified by to the query (in this case, Chicago, Ill.) as well as additional markers. In particular, the map region 604 includes hotel markers 606 for identifying the location of specific hotels within the geographic region. In some implementations, a marker is directly selectable by a user in order to obtain additional information about the hotel. In addition, the map region 604 shows an adjustable polygon-shaped filter 608. The polygon-shaped filter 608 encompasses an area identified to contain a threshold number of points of interests. Only hotels within the polygon-shaped filter 608 are indicated. In addition, the polygon-shaped filter is adjustable to increase or decrease the number of hotels shown. In particular, the map region 604 indicates the geographic location for the point of interest “Old Town Triangle Theater” in Chicago using a map indicator 610. The map indicator 610 provides a reference point for the user when deciding between candidate hotels. In particular, the user can use the map region 604 to determine which candidate hotels are closest to the point of interest. In some implementations, users can refine the number of hotels displayed on a map by selecting the map indicator 610. For example, a user can click on the map indicator 610 to specify that only hotels located within a specified distance from the map indicator 610 should be displayed on the map interface 600 (e.g., display hotels located within 10 blocks of the map indicator).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device. e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the to user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method, the method comprising:
receiving a search query, where the search query includes one or more terms;
identifying one or more locations associated with the one or more terms prior to execution of the search query;
providing the one or more locations as query suggestions;
receiving a selection of a location; and
in response to the selection, determining that the selected location references a hotel and providing a hotel search results interface, the hotel search results interface including a first region displaying one or more hotel listings, where the hotels listings include hotels located within a geographic region containing the selected hotel, and a second region, where the second region is configured to present one or more user selected hotels from the one or more hotel listings.

2. The method of claim 1, wherein the hotel search results interface includes a third region that is configured to present a hotel card for the hotel corresponding to the selected location as an overlay to the first and second regions.

3. The method of claim 1, wherein the hotel corresponding to the selected location is added to a shortlist of user selected hotels.

4. A computer-implemented method, the method comprising:
receiving a search query, where the search query includes one or more terms;
identifying one or more locations associated with the one or more terms prior to execution of the search query;
providing the one or more locations as query suggestions;
receiving a selection of a location; and
in response to the selection, determining that the selected location references a point of interest and providing a map interface, the map interface including a map of a geographic region that includes the point of interest, wherein the map interface identifies the selected point of interest and hotels located within the geographic region including the selected point of interest.

5. The method of claim 4, wherein the selected point of interest is identified using a marker, and wherein the marker is selectable by a user to obtain additional information about the point of interest.

6. The method of claim 4, further comprising:
receiving a second search query, where the second search query includes one or more terms;
identifying one or more locations associated with the one or more terms prior to execution of the second search query;
providing the one or more locations as query suggestions;
receiving a second selection of a location; and
in response to the second selection, determining that the selected location references a second point of interest and updating the map interface, the map interface including a map of a geographic region that includes the point of interest and the second point of interest, wherein the map interface identifies the point of interest, the second point of interest, and hotels located within the geographic region including the selected point of interest.

7. The method of claim 4, further comprising:
receiving user input for removing the selected point of interest from the map interface; and
updating the map interface to remove the selected point of interest.

8. A system comprising:
a user device; and
one or more computers configured to interact with the user device and to perform operations comprising:
receiving a search query, where the search query includes one or more terms;
identifying one or more locations associated with the one or more terms prior to execution of the search query;
providing the one or more locations as query suggestions;
receiving a selection of a location; and
in response to the selection, determining that the selected location references a hotel and providing a hotel search results interface, the hotel search results interface including a first region displaying one or more hotel listings, where the hotels listings include hotels located within a geographic region containing the selected hotel, and a second region, where the second region is configured to present one or more user selected hotels from the one or more hotel listings.

9. The system of claim 8, wherein the hotel search results interface includes a third region that is configured to present a hotel card for the hotel corresponding to the selected location as an overlay to the first and second regions.

10. The system of claim 8, wherein the hotel corresponding to the selected location is added to a shortlist of user selected hotels.

11. A system comprising:
a user device; and
one or more computers configured to interact with the user device and to perform operations comprising:
receiving a search query, where the search query includes one or more terms;
identifying one or more locations associated with the one or more terms prior to execution of the search query;
providing the one or more locations as query suggestions;
receiving a selection of a location; and
in response to the selection, determining that the selected location references a point of interest and providing a map interface, the map interface including a map of a geographic region that includes the point of interest, wherein the map interface identifies the selected point of interest and hotels located within the geographic region including the selected point of interest.

12. The system of claim 11, wherein the selected point of interest is identified using a marker, and wherein the marker is selectable by a user to obtain additional to information about the point of interest.

13. The system of claim 11, further comprising:
receiving a second search query, where the second search query includes one or more terms;
identifying one or more locations associated with the one or more terms prior to execution of the second search query;
providing the one or more locations as query suggestions;
receiving a second selection of a location; and
in response to the second selection, determining that the selected location references a second point of interest and updating the map interface, the map interface including a map of a geographic region that includes the point of interest and the second point of interest, wherein the map interface identifies the point of interest, the second point of interest, and hotels located within the geographic region including the selected point of interest.

14. The system of claim 11, further comprising:
receiving user input for removing the selected point of interest from the map interface; and
updating the map interface to remove the selected point of interest.

15. A computer storage medium encoded with a computer program, the program comprising instructions that when executed by data processing apparatus cause the data processing apparatus to perform operations comprising:
receiving a search query, where the search query includes one or more terms;
identifying one or more locations associated with the one or more terms prior to execution of the search query;
providing the one or more locations as query suggestions;
receiving a selection of a location; and
in response to the selection, determining that the selected location references a hotel and providing a hotel search results interface, the hotel search results interface including a first region displaying one or more hotel listings, where the hotels listings include hotels located within a geographic region containing the selected hotel, and a second region, where the second region is configured to present one or more user selected hotels from the one or more hotel listings.

16. The computer storage medium of claim 15, wherein the hotel search results interface includes a third region that is configured to present a hotel card for the hotel corresponding to the selected location as an overlay to the first and second regions.

17. The computer storage medium of claim 15, wherein the hotel corresponding to the selected location is added to a shortlist of user selected hotels.

18. A computer storage medium encoded with a computer program, the program comprising instructions that when executed by data processing apparatus cause the data processing apparatus to perform operations comprising:
receiving a search query, where the search query includes one or more terms;
identifying one or more locations associated with the one or more terms prior to execution of the search query;
providing the one or more locations as query suggestions;
receiving a selection of a location; and
in response to the selection, determining that the selected location references a point of interest and providing a map interface, the map interface including a map of a geographic region that includes the point of interest, wherein the map interface identifies the selected point of interest and hotels located within the geographic region including the selected point of interest.

19. The computer storage medium of claim 18, wherein the selected point of interest is identified using a marker, and wherein the marker is selectable by a user to obtain additional information about the point of interest.

20. The computer storage medium of claim 18, further comprising:
receiving a second search query, where the second search query includes one or more terms;
identifying one or more locations associated with the one or more terms prior to execution of the second search query;
providing the one or more locations as query suggestions;
receiving a second selection of a location; and
in response to the second selection, determining that the selected location references a second point of interest and updating the map interface, the map interface including a map of a geographic region that includes the point of interest and the second point of interest, wherein the map interface identifies the point of interest, the second point of interest, and hotels located within the geographic region including the selected point of interest.

21. The computer storage medium of claim 18, further comprising:
receiving user input for removing the selected point of interest from the map interface; and
updating the map interface to remove the selected point of interest.
